(19) United States
(12) Patent Application Publication
(10) Pub. No.: US 2005/0087613 A1
(43) Pub. Date: Apr. 28, 2005

(54) Method for regulation of displacement conditioners, and system

(76) Inventor: Roberto Trecate, 27100 Pavia (IT)

Correspondence Address: NIXON & VANDERHYE, PC, 1100 N GLEBE ROAD, 8TH FLOOR, ARLINGTON, VA, 22201-4714, US

(21) Appl. No.: 10/500,956

(22) PCT Filed: Dec. 30, 2002
(86) PCT No.: PCT/EP02/14792

(30) Foreign Application Priority Data
Jan. 8, 2002 (IT) MI2002 A 000011

(51) Int. Cl. F24F 7/00

(52) U.S. Cl. 236/49.1

(57) ABSTRACT

Combined regulation of the power supplied by the conditioner and of the air flow rate of the conditioner is carried out so as to maintain the temperature gradient between air entering and air leaving the same conditioner high, in order to allow perfect functioning of displacement system (without mixing) in any condition of service.

The present invention relates to the field of cooling of objects by means of displacement ventilation.

According to the so-called technique of “displacement”, in itself known, in a room a flow of cold air is supplied at low speed at floor level.

The conditioner or refrigerator which supplies this flow can be outside or inside the room. The cold air, denser, is spread over the entire floor. When the cold air comes into contact with the heat sources in the room, for example equipment to be cooled, it heats and an ascending movement is generated by convection. The heated air near the ceiling of the room is aspirated by the conditioner, cooled and returned into circulation. The features which distinguish displacement ventilation are the low speed of the air, for which some books define the upper limit of 0.5 m/s, and the fact that the cooling air, that is to say the air emitted by the conditioner, which air passes along the heat sources to be cooled and returns to the conditioner, is not mixed with the ambient air, or only mixes with it minimally.

Cooling of the displacement air can be carried out both with air diffusers placed inside the room to be cooled, connected to air conditioners placed externally via a network of ducts, or directly with air conditioners placed inside the room.

The movement of cooling air in a displacement system is caused by the thermal gradient between the cold cooling air at floor level and the heated cooling air at ceiling level. It is therefore decisive to maintain this thermal gradient close to the design value or above a preset limit for proper working of the system.

An object of the invention is to maintain the gradient always above a certain limit value.

The thermal gradient is linked to the air flow rate and to the heat load of the room. At the same air flow rate, the gradient is greater if the heat load is greater. At the same heat load, the gradient is greater if the air flow rate is lower.

The heat load of a room depends on the endogenous heat emitted by the equipment located in the room, on the endogenous heat emitted by the persons, in the room, and on the heat exchanged via the structures (walls, floor, ceiling) between the room and the outside.

The heat load varies in time substantially because both the endogenous heat emitted by the equipment and by the persons and the heat exchanged, which depends on the conditions inside and outside the room, vary.

According to the state of art prior to this invention, in systems with displacement cooling regulation takes place by controlling the power supplied by the conditioner. The traditional system however does not succeed in preventing variations in the temperature gradient completely and, when the temperature gradient decreases excessively, this prevents proper functioning of the displacement system.

To avoid the problems mentioned, provision is made for the regulation method according to the invention, as claimed in claim 1 and the system as claimed in claim 7. Further new and useful features are claimed in the dependent claims. The method of regulation, in other words, provides for joint and sequential regulation of the power supplied by the conditioner and of the air flow rate of the conditioner. The regulation can be of the modulating type both for the air flow rate and for the power. Or modulating regulation of the power and regulation by discrete steps for the air flow rate can be provided. Or regulation by discrete steps of the air flow rate and of the power can be provided. Or finally modulating regulation of the air flow rate and discrete step regulation of the power can be provided.

The new regulation method achieves the objects stated above and remedies the disadvantages described above relating to the state of the art. In particular it maintains the temperature gradient always equal or very close to the design value. Moreover there is an advantage as regards the electricity consumption of the fans, in that the power that they must supply decreases strongly as the ambient temperature decreases.

Non-limiting examples of embodiments of the invention are to be described herein below with reference to the accompanying drawings, in which:

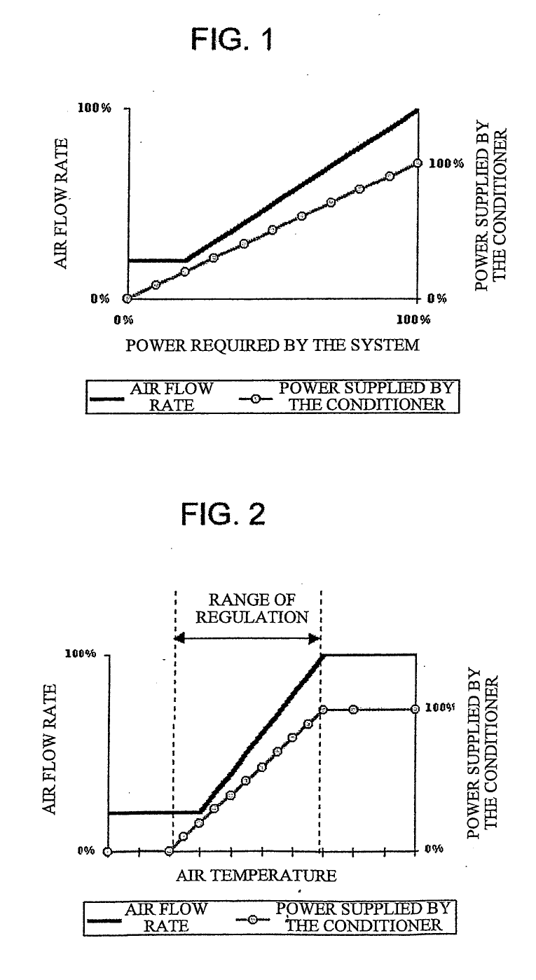

FIG. 1 is a graph which illustrates the method of regulation of the invention in the case of modulating regulation of both the air flow rate and power supplied by the conditioner (both plotted on the Y axis), as a function of the power required by the system (or system load, plotted on the X axis); the air flow rate is indicated by an unbroken line, and the power supplied by the conditioner is indicated by a dotted line;

FIG. 2 is a graph for the case of FIG. 1, wherein the modulation of the air flow rate and the power of the conditioner are plotted as a function of the temperature measured (X axis); the graphic signs for the air flow rate and for the power supplied by the conditioner, plotted on the Y axis, are the same as in FIG. 1;

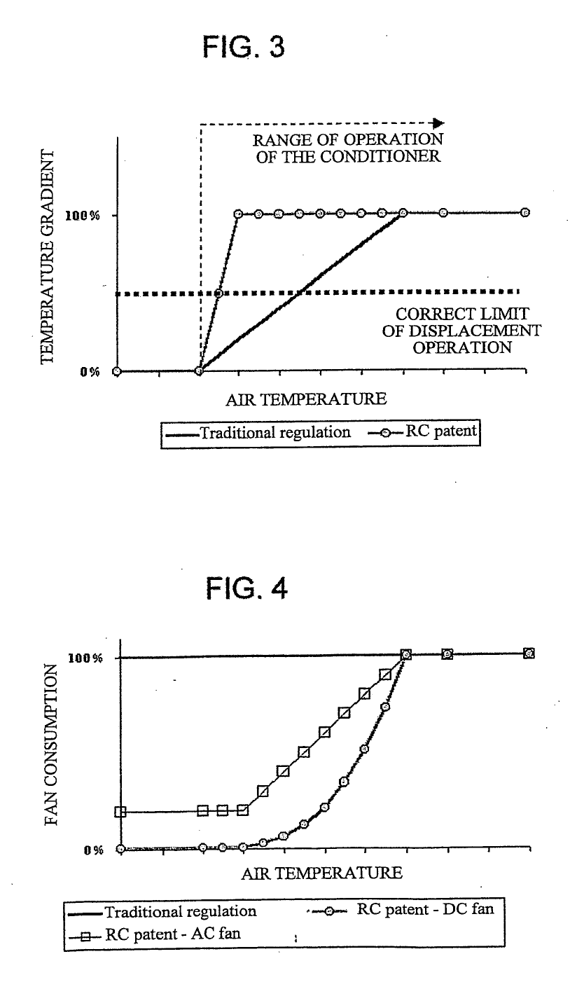

FIG. 3 is a graph which illustrates an advantage of the invention, in the case of regulation as in FIG. 1; in particular the fact that the temperature gradient (on the Y axis), is maintained constant while the air temperature varies (on the X axis), the unbroken line indicates the trend of the temperature gradient with traditional regulation, the dotted line illustrates the trend of the temperature gradient with regulation according to the invention; the thicker, horizontal, dashed line indicates the design gradient for proper displacement functioning;

FIG. 4 is a graph which illustrates another advantage of the invention, i.e. reduction of the fan consumption; the fan consumption rates are indicated on the Y axis as a function of the air temperature, plotted on the X axis: the unbroken line indicates the consumption for traditional regulation, the dotted line indicates the consumption for regulation according to the invention, in the case of a direct current fan; the chequered line indicates the consumption for regulation according to the invention, in the case of an alternating current fan;

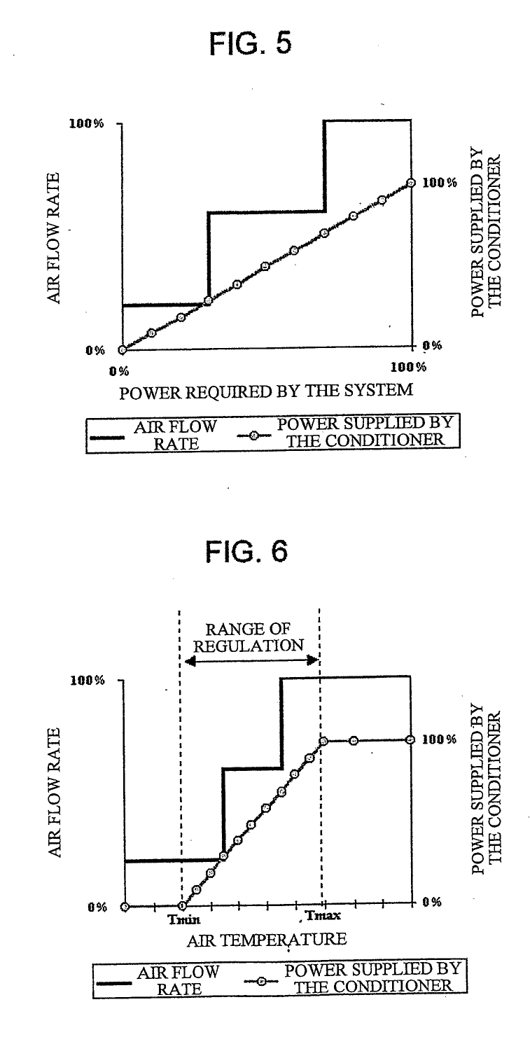

FIG. 5 is a graph which illustrates the regulation method in the embodiment with stepped regulation of the air flow rate (on the Y axis as an unbroken line) and modulating regulation of the power (on the Y axis as a dotted line) as a function of the power required by the system (on the X axis);

FIG. 6 illustrates the embodiment of the invention as for FIG. 5, but the air flow rate and the power supplied by the conditioner, indicated by the same graphic form as for FIG. 5, are plotted as a function of the air temperature;

FIG. 7 illustrates the trend of the temperature gradient (on the Y axis) as a function of the air temperature (on the X axis), for traditional regulation (unbroken line) and for regulation as in FIG. 6 (dotted line), and the design gradient (thick, horizontal, dashed line);

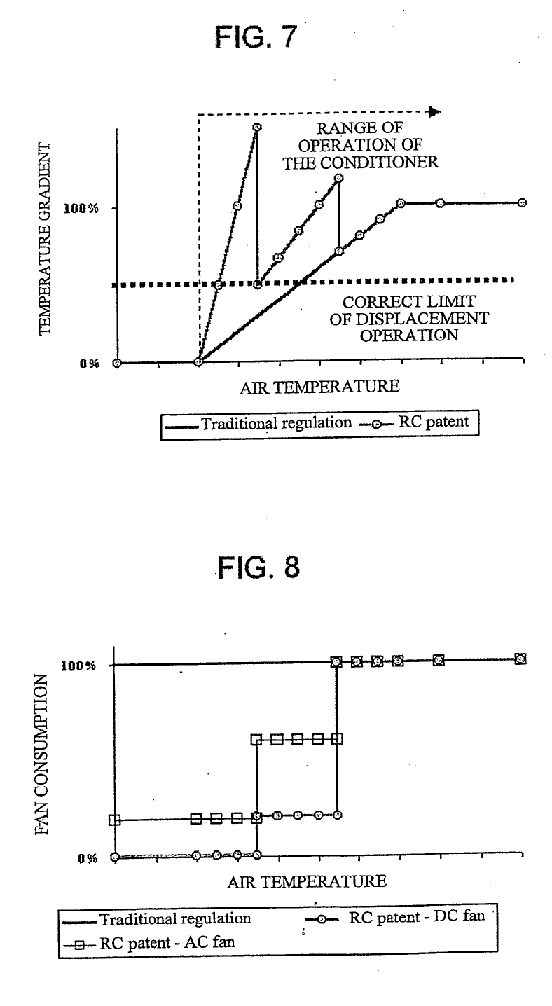

FIG. 8 illustrates the consumption of the fan (on the Y axis) as a function of the air temperature (on the X axis) for traditional regulation (unbroken line) and for regulation as in FIG. 6, in the case of a fan with direct current supply (dotted line) and in the case of a fan with alternating current supply (chequered line);

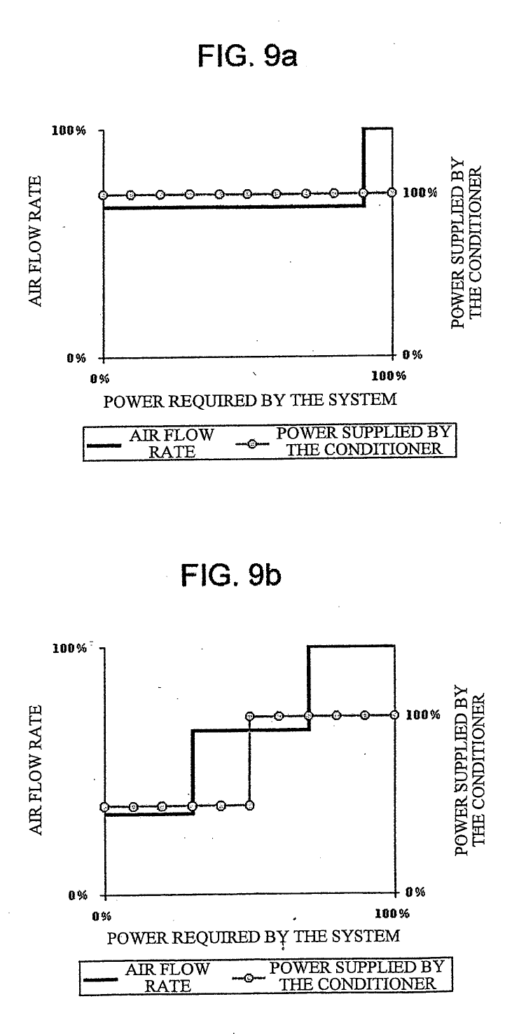

FIG. 9 illustrates in a first graph (a) stepped regulation of the air flow rate (unbroken line) with constant power supplied by the conditioner (dotted line), and in a second graph (b) stepped regulation both of the air flow rate (unbroken line) and of the power supplied by the conditioner (dotted line), in both cases as a function of the power required by the system;

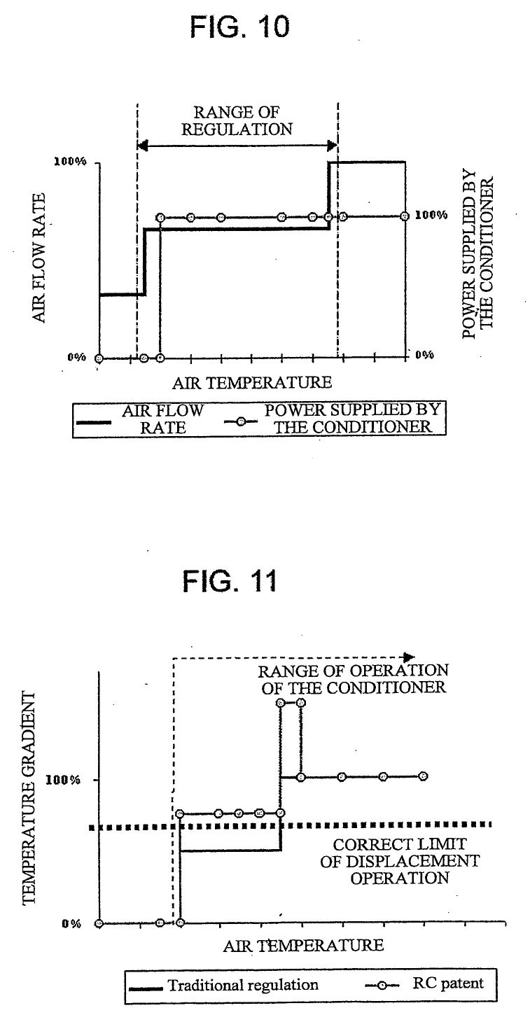

FIG. 10 illustrates in a graph, as a function of the air temperature, stepped regulation of the air flow rate (unbroken line) and of the power supplied by the conditioner (dotted line);

FIG. 11 illustrates in a graph as a function of the air temperature, the temperature gradient obtained for traditional regulation (unbroken line) and for regulation according to FIGS. 9 and 10 (dotted line); the design gradient is shown by the thick, horizontal, dashed line;

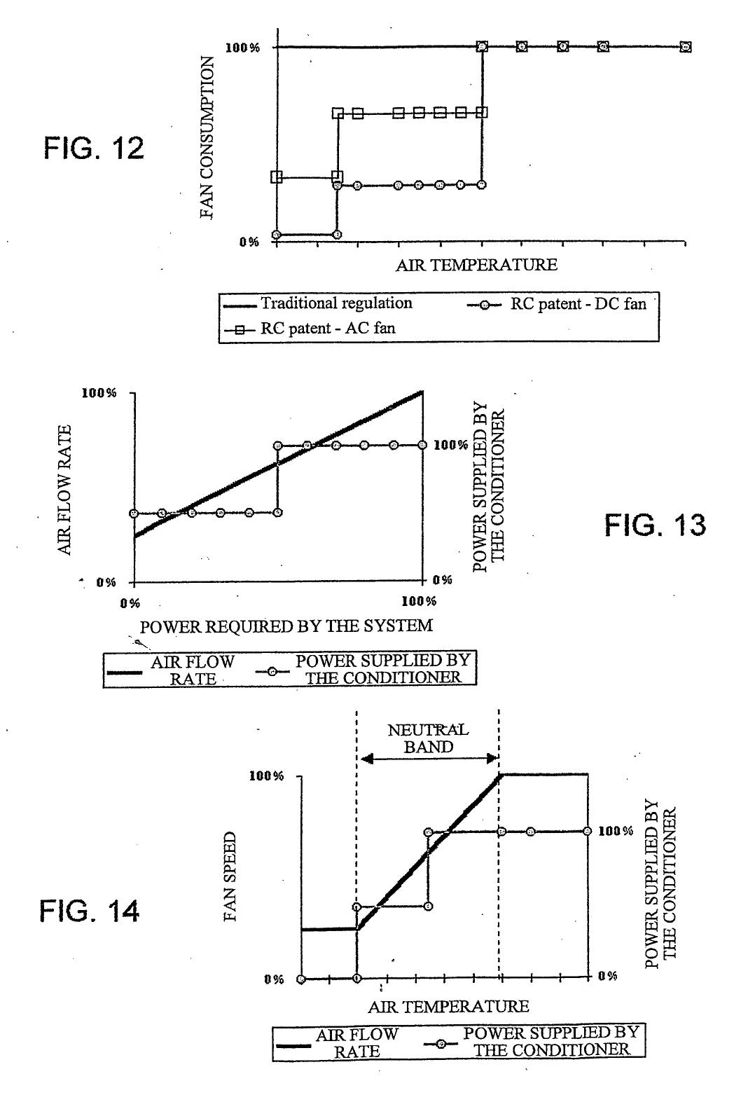

FIG. 12 illustrates in a graph the advantages for the consumption of the fan as a function of the air temperature; the consumption of the fan is plotted on the Y axis as an unbroken line for traditional regulation, as a dotted line for regulation according to FIGS. 9 and 10 and for a direct current fan, as a chequered line for an alternating current fan and regulation as in FIGS. 9 and 10;

FIGS. 13 and 14 refer to an embodiment with modulating regulation of the air flow rate (unbroken line) and stepped regulation of the power supplied by the conditioner (dotted line); on the X axis in FIG. 13 the power required by the system is plotted and in FIG. 14 the air temperature.

The object of this patent application is a method of regulation of conditioners for a room, functioning according to the displacement principle or the like, and hence a regulation method which allows constant maintaining, in the room to be conditioned, of a design temperature gradient or higher than the design gradient, irrespective of the power required by the same room. According to the new method combined regulation is carried out of the power supplied by the conditioner and of the air flow rate of the conditioner. The air flow rate can be varied by varying the number of revs of the fan or by using air locks, or in another manner.

According to the new method, more particularly, a variation in the air temperature is measured indicating the variation in the load required (of the power required) by the system, by means of sensors placed inside or outside the conditioner. The temperature measured can be that of the delivery air, or of the return air, or both. As a function of the this/these temperature/s measured the air flow rate and power are regulated, so as to maintain the gradient substantially at the preset value.

The combined regulation of the air flow rate and of the power can be carried out in various ways.

FIGS. 1-4 refer to a first embodiment of the invention whereby “modulating” regulation is carried out both of the air flow rate and of the power. In this text the term “modulating” refers to a variation of the parameter controlled (power and/or flow rate) with continuous functioning, without any discontinuity. In the first embodiment, at 100% of the power required by the system, both the power supplied by the conditioner and the air flow rate are 100% (design data). As the load or power required by the system decreases, both are reduced, according to any trend. FIGS. 1 and 2 illustrate a linear variation. Provision is made for the air flow rate not to drop below a minimum value so as to improve the sensitivity of the temperature sensors and/or for moving in any case the air in the room. In practice regulation of the air flow rate and of the power is carried out as a consequence of the air temperatures measured, as shown in FIG. 2, rather than as a consequence of the measurement of the load required, the temperatures being indicative of this load. The regulation of both parameters (power of the conditioner and air flow rate) takes place within a certain regulation range, defined by vertical dashed lines in FIG. 2. The width of the regulation range is irrelevant and only depends on the control precision to be obtained. Within this range the regulation method described above is applied.

With the regulation method described above, the temperature gradient is maintained constant and equal to 100% (design value), while with the traditional regulation method, based on regulation of the power of the conditioner alone, the gradient decreased even as far as values such as to prevent proper functioning of the system according to the displacement principle. Moreover a significant advantage is obtained as regards electricity consumption of the fans, as shown in FIG. 4, in the case of variation of the flow rate taking place by modifying the revs of the fan itself. That is to say, whereas with the traditional regulation method the consumption of the fans was always equal to 100%, according to the variation in the ambient temperature, with the method of regulation shown in FIGS. 1 and 2 there is a considerable reduction in the consumption of the fan/s, to a different extent for alternating current fans and for direct current fans.

A second embodiment of the invention is illustrated with reference to FIGS. 5-8. At 100% of the power required by the system both the power supplied by the conditioner and the air flow rate are equal to 100% (design data). The regulation is carried out by varying, by discrete steps (any number of steps) the air flow rate, and continuously, with any trend (modulating variation), the power supplied by the conditioner, as the power required by the system varies, or rather as the temperature of the air measured varies. The air flow rate can also be maintained at a minimum value, in the case of minimum power required by the system, to improve the sensitivity of the temperature sensors and/or move in any case the air in the room. In FIG. 6 two vertical dashed lines define the range of regulation; the weight of the range of regulation is irrelevant and depends on the control precision to be obtained. The temperature values, at which the various steps of the air flow rate are activated, can vary, provided the temperature gradient is greater than the minimum allowed for proper functioning of displacement.

The advantages of the second embodiment are similar to those of the first manner, in particular, as can be seen in FIG. 7, the gradient is always maintained above the lower threshold for proper functioning of displacement. Moreover, as shown in FIG. 8, in the case of the flow rate variation taking place by variation of the revs of the fan, the consumption of the fan/fans decreases as the temperature of the ambient air decreases (therefore of the power required by the system). The reduction is different according to whether the fans are supplied with alternating current or with direct current.

In a third embodiment of the invention regulation by discrete steps is carried out both of the air flow rate and of the power. The embodiment is illustrated in FIGS. 9-12.

The stepped regulation of the power is in actual fact a regulation of energy. In practice the conditioner is actuated and de-actuated but nevertheless, when actuated, always supplies 100% of the power. For example, to obtain 50% of the energy, actuation takes place for 30 minutes and de-actuation for a further 30 minutes.

In the case of one single regulation step, FIG. 9a, when the compressor is ill function, it always supplies 100% of the power. The air flow rate is equal to a fraction of the maximum, until the power required by the system approaches the maximum design power (or even exceeds it). In this case the air flow rate rises to the design maximum.

In the case of FIG. 9b, the power supplied by the conditioner is regulated in order to form two steps. The air flow rate increases by discrete steps for values of power required by the system which can vary as a function of the percentage of regulation of the power supplied by the conditioner.

As for the previous cases, in actual fact regulation is performed on the basis of the temperature of the air (delivery, return or both) read by the sensors, as can be seen in the graph in FIG. 10. Within the range of regulation the air flow rate decreases by discrete steps. The width of the range of regulation is irrelevant and only depends on the control precision to be obtained. The temperature values at which the various steps of the air flow rate are activated can vary. The steps can be activated for lower values at the minimum temperature of the range of regulation and deactivated also for values higher than the maximum temperature of the range of regulation.

The advantages are in particular, as mentioned in relation to the other embodiments, that the regulation method maintains the temperature gradient always above an established threshold value, and allows a considerable reduction in the consumption of the fans as the ambient temperature decreases, compared to the traditional regulation system. The reduction is more noticeable for fans supplied with direct current.

According to a fourth embodiment, modulating regulation of the air flow rate and regulation by discrete steps of the power are carried out, as illustrated in FIG. 13, as a function of the power required by the system and in FIG. 14 as a function of the temperature of the air (delivery, return/ambient or both). Within the range of regulation, defined by the vertical dashed lines, the air flow rate decreases continuously with any trend as the temperature decreases, and the power supplied by the conditioner decreases by steps. The advantages are as mentioned with reference to the previous embodiments.

1. Regulation method of displacement conditioners as a function of the power required or load required, said method comprising regulation of the power supplied by the conditioner, characterised in that it also comprises combined regulation of the air flow rate supplied by the conditioner.

2. Method according to claim 1, characterised in that the reference parameter measured for regulation is the temperature of the delivery air and/or the return air or ambient air.

3. Method according to claim 1, characterised in that modulating regulation is carried out both of the air flow rate and of the power of the conditioner, according to any trends.

4. Method according to claim 1, characterised in that modulating regulation of the power and regulation by discrete steps of the air flow rate are carried out.

5. Method according to claim 1, characterised in that regulation by discrete steps is carried out both of the air flow rate and of the power of the conditioner.

6. Method according to claim 1, characterised in that modulating regulation of the air flow rate and regulation by discrete steps of the power of the conditioner are carried out.

7. Ventilation conditioning system characterised by combined regulation of the power supplied by the conditioner and of the air flow rate supplied by the conditioner.

8. System according to claim 7, with regulation according any one of claims 1-6.
